(19) United States
(12) Patent Application Publication
(10) Pub. No.: US 2001/0047725 A1
(43) Pub. Date: Dec. 6, 2001

(54) Method and apparatus for the manufacture of glued structures

(76) Inventor: Ola Hugosson, Skillingaryd (SE)

Correspondence Address: David J. Serbin, Unit 2, First Floor, 1423 Powhatan Street, Alexandria, VA, 22314, US

(21) Appl. No.: 09/741,094

(22) Filed: Dec. 21, 2000

Related U.S. Application Data
(60) Provisional application No. 60/174,597, filed on Jan. 5, 2000.

(30) Foreign Application Priority Data
Dec. 23, 1999 (EP) 99850212.4

(51) Int. Cl. B30B 15/34

(52) U.S. Cl. 100/38; 100/92

(57) ABSTRACT

The invention relates to a method of manufacturing a glued structure, said structure comprising individual components bonded together by glue. It comprises assembling the components to an aggregate with glue between, and simultaneously exposing the aggregate of material and glue under pressure to both high frequency electromagnetic energy and to direct heating, for a sufficient period of time to bring the glue to a cured or hardened state.

An apparatus according to the invention comprises a mold (2) having a first and a second mold part (4, 6) each having a press surface which is made of metal; heating elements (11, 17, 18, 19) for heating the press surface of each mold part; means for supplying RF energy to the mold and an RF filter (13) for preventing RF energy to dissipate.

The present invention relates to manufacture of structures by gluing, e.g. for the production of furniture components, board products etc.

### BACKGROUND OF THE INVENTION

When wood and other similar materials are glued together for the manufacture of complex structures such as furniture components and construction components, or when particulate materials are used for the manufacture of board products, e.g. chip board, particle board, fiber board etc., use is commonly made of a glue which has the property of reacting to an increased temperature by creating a faster bonding between the components subject to the gluing process. Today there are essentially two different ways of heating a glue joint which is located inside a structure, such as is the case with complex components for furniture, or for boards where the glue is distributed through-out the entire product.

A first method involves employment of heated press tools, often heated by steam or hot water, or by electrical heating devices. This method has a disadvantage in that the heating time for components located inside the structure to be assembled by gluing, is determined by the thickness of the structure, and the heat conducting capacity of the material (e.g. wood), i.e. the time it takes for the heat energy to be transported into the inner parts of the structure.

Another method involves employment of high-frequency electromagnetic energy (e.g. RF energy). The components to be bonded by gluing are positioned in a press between two press parts, and the heating is achieved by subjecting the structure to the high-frequency energy. A limitation of this method is that the RF energy generates most of the heat in the inner parts of the material. Simultaneously the press tool in practice cools the outermost glue joint. Thus, the process time is determined by the curing time of the outermost joint. In the above mentioned first method the converse is true, i.e. the outermost joint will cure first.

### SUMMARY OF THE INVENTION

Thus, there is a need for an improved method of joining components (or for making board) by gluing, wherein the curing process is sufficiently fast, and wherein an optimal heating is achieved, thereby saving energy expenditure and wherein the overall process time is reduced.

The object of the present invention is therefore to improve known methods such that the glue is cured at an essentially even temperature through-out the entire structure that is manufactured, thereby reducing production time, and energy consumption.

This object is achieved in a first aspect of the invention with a method of manufacturing glued structures, which is characterized by combining high frequency energy heating (e.g. RF energy) with direct heating by using press tools heated by steam, hot water or electrical means.

The method according to the invention is defined in claim 1, and comprises simultaneously exposing an aggregate of material and glue under pressure to both high frequency electromagnetic energy and to direct heating, for a sufficient period of time to bring the glue to a cured or hardened state.

The advantages of the inventive method compared to prior art methods are, shorter process time for thicknesses where today the RF technique is employed; more uniform heating which reduces the risk of shape distortions and thereby reduce scrapping rate; reduced energy consumption compared to when only RF energy is used for heating; and less wear on the RF generator, in particular its oscillator tube.

In a second aspect of the invention there is provided an apparatus for manufacturing glued structures. The apparatus is defined in claim 6.

### BRIEF DESCRIPTION OF THE DRAWINGS

The invention will now be describe with reference to the attached drawings in which

FIG. 1 shows schematically a typical mold for the manufacture of form bent objects, provided with a heating system according to the invention;

FIG. 2 shows schematically a mold for manufacturing flat objects, provided with a heating system according to the invention; and

FIG. 3 is a partial cross section through a mold part having electrical heating means.

### DETAILED DESCRIPTION OF THE INVENTION

For the purpose of this application, the term “glued structure” shall be taken to mean any object that is made up of individual components, bonded together with a glue to form a composite (solid) object. Thus, laminated structures such as form bent parts for furniture (arm rests, seats etc) are included. Also, board products of various kinds, wherein wood particles are bonded together to form objects are included in this definition. Construction beams made of small wood pieces joined to larger structures are also included.

For the purpose of this application, the term “component” of a glued structure shall be taken to mean any form of a material, from particles, such as dust, chips, fibers, to macroscopic component parts of e.g. a piece of furniture, that can be assembled by gluing to a composite product.

For the purpose of this application, the term “product” shall be taken to mean the result of the method according to the invention, regardless of whether it is a final product or an intermediate product, such as a frame for a sofa or the like, in the case of furniture, or in the case of board, an uncut “endless mat” exiting from a continuous production line.

“Direct heating” shall be taken to mean heating by exposing the surface of an object to heat from some source, e.g. by contacting it to an electrically heated surface, or a surface heated by steam or hot water. The heat control can be of the ON/OFF type, i.e. energy can be supplied intermittently and a thermostat can be used to activate/deactivate energy supply. Of course energy can also be supplied continuously.

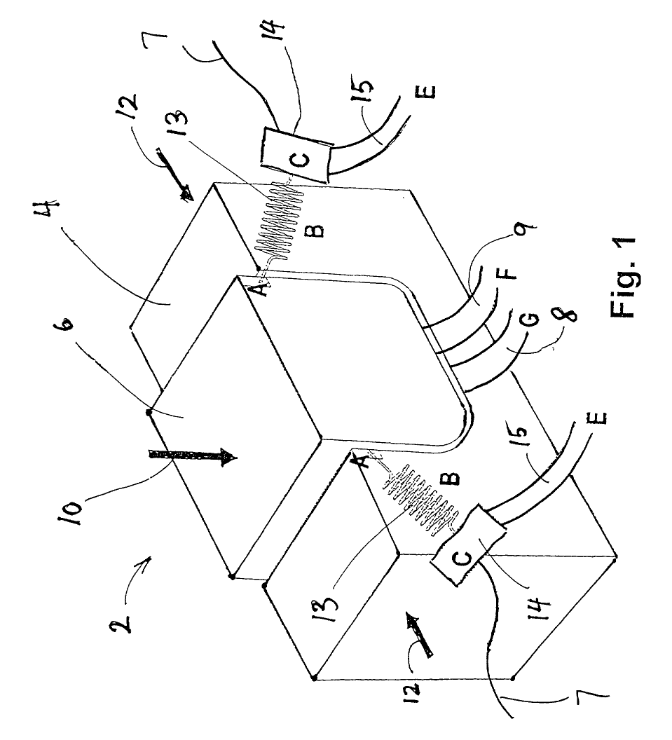

FIG. 1 shows schematically a mold 2, usable in the manufacture of e.g. arm rests for chairs, and which has the combined heating system according to the invention. The mold 2 comprises a die 4 and a counter-die 6. A mold of this type is commonly made from a large number of stacked sheets of plywood, where the edge portions form the surface on which the shaping of the material in the molding operation takes place. Suitably the surface is covered with a metal sheet, preferably of aluminium, such that the material to be treated rests against the sheets during the process. Sometimes molds are made of solid metal, especially when steam or hot water is used for heating. In such cases the water/steam is passed through channels in the mold metal. However, metal molds are expensive, and only if the steam/water energy is sufficiently inexpensive, this type of mold is economically feasible.

Another heating method comprises providing a recessed aluminium profile 11, 150 mm wide, 6.5 mm thick and 5 m long on the mold parts 4, 8. A part of such a structure is shown in FIG. 3, which is a cross section through a mold part 4. Although aluminium is preferred, steel can also be used, but if steel is used it is recommended to provided a thin A1 sheet underneath for optimal energy distribution. Suitably there are about 15 recesses 18 running in parallel in the longitudinal direction and on one side of the profile. The opposite surface of the profile is planar. The surfaces of the die and the counter-die respectively are clad with profiles as described above, the planar surface facing outwards. In the recesses there are provided heating cable 19 dimensioned to yield heating power of say 3000 W/m², although this value will of course be adapted to the actual case. The entire inner surface of the mold parts are finally covered with A1-sheets 17, 2-3 mm thick, to form flat pressing surfaces in the mold.

For RF heating, AC voltage in the frequency range 2-40 MHz, preferably 5-40 MHz could be used, but because of governmental safety regulations relating to safety aspects in communication for air traffic, frequencies of either 13.56or 27.12 MHz are commonly used. The principle employed is to make use of the dipole character of water. In an alternating electric field, the water molecules will change orientation, the movement of the molecules thereby causing the heating.

The RF energy can be produced by an RF generator, which comprises a transformer, transforming the voltage from e.g. 380 V to about 10000 V. The AC voltage is rectified to a DC voltage by suitable diodes, and the DC voltage is fed to an oscillator, a triode, which generates a very high frequency (e.g. 13.56 MHz). The high frequency voltage is applied to the metal sheets provided on the surfaces in the mold.

For the manufacture of a selected product using a prior art mold of this type, a veneer packet, suitably glued together, is placed in the die 4, and the counter-die 6 is pressed downwards by hydraulic means, indicated by an arrow 10 in FIG. 1. During the compression, heat is supplied by external means, either by RF heating, or by steam heating or electrical heating means, as already discussed in the preamble.

When the shape of the product is such that the pressure from above will exert only a fraction of the nominal pressure on some portions of the product, e.g. as shown in FIG. 1 where the vertical portions of the object to be treated will hardly be subjected to any pressure from above, it is necessary to provide hydraulic press means also acting on the sides of the mold (indicated by arrows 12).

FIG. 1 discloses schematically a first embodiment of a molding apparatus according to the invention.

As already indicated, it comprises a die 4 and a counter-die 6, preferably made from plywood, as described above, and provided with an electrical heating system as disclosed in FIG. 3. More details of the electrical heating will be given below.

In addition to the electrical heating, there is provided RF heating. Thereby each aluminium surface of the die 4 and counter-die 6 respectively, is connected to a thin foil 8, and 9 respectively, preferably made of brass, each of which in turn is connected to a RF generator (not shown). Preferably the foils are about 10-15 cm wide, although other dimensions may be suitable for specific applications.

Another part of each metal surface is connected to ground via an RF filter 13 or “capacitor” in the form of a spiral wound metal tube, preferably made of copper. The electrical leads 7 for supplying the electrical heating with energy run inside the copper tube 13. By placing the leads inside the spiral tube, the filter acts as a shield and prevents RF energy to leak to peripheral equipment, where it could cause disturbance and possibly damage. A control unit 14 located inside a shielded box containing equipment for regulating the temperature of the electrically heated surface is also connected to the filter.

Temperature control is obtained by having sensors (not shown) positioned at appropriate locations in the mold, and in response to the temperature signal from the sensor, the voltage applied to the heated surfaces will be regulated. The leads connecting the sensors also run inside the spiral tube, and will thus also be shielded/protected from the influence of the RF field. The connection to ground is achieved with a foil 15, same as for the other connection, namely brass, attached to the metal surface of each mold part, and will suitably be connected at the closest suitable grounding point on the press stand.

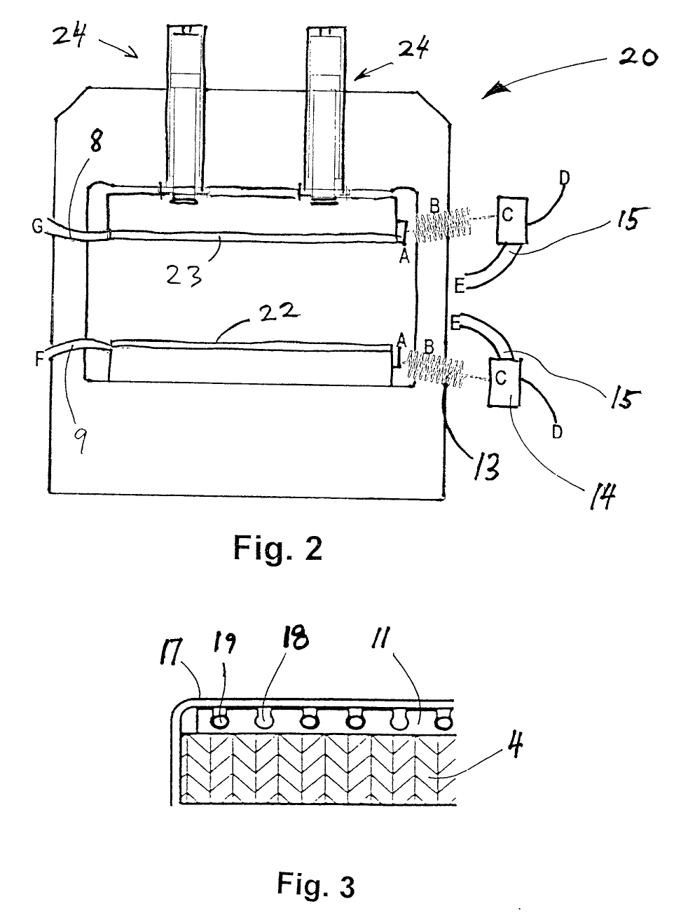

In FIG. 2 there is shown a flat press 20 for manufacturing flat objects. Such objects could be cross veneer, plywood, floor tiles etc. but also fiber board, chip board and the like.

The structure is principally identical to the structure disclosed in FIG. 1, and like element have been given the same reference numerals. The difference is that instead of die and counter-die, there is provided a first flat, bottom pressplate 22 on which the object to be compressed is placed, and a second flat, upper pressplate 23, connected to the hydraulic system, schematically indicated at 24.

For the manufacture of e.g. plywood, a stack of sheets of thin veneer having glue applied between the sheets is placed in the press. The press is activated and the heating is commenced, and continued for a period of time sufficient to cure the glue.

For the manufacture of board (fiber, chip, or like), the raw material is mixed with the appropriate glue, and fed onto a conveyor belt, thereby forming a continuous mat. A cut off piece of the mat is fed into the press, where compression and heating is performed to produce a hard board, which is removed from the press and the operation is repeated.

It is also possible to manufacture floor tiles of laminated wood (parquetry) with the system and method according to the present invention.

In a preferred embodiment, the direct heating is achieved by making use of the relatively large heat capacity of the mold material. Thereby, the electrical heating energy is supplied to the pressplates only during periods of time where the RF energy is not introduced. The reason for doing this is that the RF may cause disturbances and even damage to electronic equipment in the system. Another possible danger is that the RF can cause disturbances on the internal and external power supply systems.

The intermittent energy supply is provided for by arranging a first circuit breaker that is capable of switching off the current during the time the RF generator is operative. A second circuit breaker in the control box will break the contact between the apparatus and the electronics as soon as the first circuit breaker cuts the current supply.

The following example will show the saving in energy consumption when using the combination of RF heating and conventional heating as compared to only using RF heating, and to using only direct heating.

### EXAMPLE

### (Energy demand for formpressing)

| | |
|---|---|
| Weight of part processed: 4.5 kg, 23 mm thick. | |
| Conventional RF heating using 0.8 kWh per piece | = 0.18 kWh per kg. |
| Multiheating according to the invention less | = 0.12 kWh per kg. |
| than 0.52 kWh | |
| Weight of parts processed: 14 kg, 16 mm thick. | |
| The tests are done in a production of 980 kg. | |
| Direct electrical heating 70 kWh | = 0.07 kWh per kg. |

This example clearly demonstrates that the method according to the invention gives a significant reduction in energy consumption compared to when only RF heating is used, but is still not as economical as when only direct heating is used.

However, if the time factor, i.e. the time to finish curing is accounted for, the method according to the invention will have a clear advantage over even the direct heating method.

1. A method of manufacturing a glued structure, said structure comprising individual components bonded together by a glue, comprising the following steps:
providing components of a material to be formed to a product by gluing the components together;
applying a glue to the components of the material;
assembling the components to an aggregate;
exposing the material with glue applied, to a pressure in a mold;
simultaneously exposing the aggregate of material and glue under pressure to both high frequency electromagnetic energy and to direct heating, for a sufficient period of time to bring the glue to a cured or hardened state.

2. The method as claimed in claim 1, wherein the direct heating is achieved by intermittently supplying energy to said mold.

3. The method as claimed in claim 1, wherein said components are pieces of a material selected from the group consisting of wood, synthetic polymer, metal, ceramic, or combinations thereof.

4. The method as claimed in claim 1, wherein the high frequency electromagnetic energy is obtained by applying an AC voltage in the frequency range of 2-40, preferably 5-40 MHz to the mold.

5. The method as claimed in claim 1, wherein the glue has the property of decreasing its curing time when exposed to heat.

6. An apparatus for the manufacture of a glued structure, said structure comprising individual components bonded together by a glue, the apparatus comprising
a mold (2) having a first and a second mold part (4, 6) each having a press surface which is made of metal;
heating elements (11, 17, 18, 19) for heating the press surface of each mold part;
at least one connector (8, 9, 15, 13, 14) for connecting each press surface to an RF generator; and
an RF filter (13) connected to said connector.

7. The apparatus as claimed in claim 6, wherein the heating elements are electrical elements (19) integrated in the press surfaces.

8. The apparatus as claimed in claim 6, wherein the heating elements comprise channels (18) in the mold, which are suitable for passing hot water or hot steam through, and which are integrated in the press surfaces.

9. The apparatus as claimed in claim 7, wherein said radio frequency filter is comprised of a spiral wound metal tube (13).

10. The apparatus as claimed in claim 9, comprising electrical leads (7) for supplying said heating elements with electrical energy, said electrical leads being provided inside said spiral wound metal tube (13).

11. The apparatus as claimed in claim 6, comprising a unit (14) for regulating the temperature of the electrically heated surface, comprising sensors positioned at appropriate locations in the mold, said control unit in response to the temperature signal from the sensor, being adapted to control the voltage applied to the heated surfaces, and wherein the electrical leads connecting the sensors to the control equipment run inside said spiral wound metal tube.

12. The apparatus as claimed in claim 1, wherein the mold (2) comprises a die and a counter die for the production of form bent objects.

13. The apparatus as claimed in claim 1, wherein the mold (2) comprises an upper and a lower flat press plate for the production of planar objects of production of planar objects.

14. The apparatus as claimed in claim 6, further comprising a first circuit breaker provided to enable selectable switching off of the current supply, in particular during periods of time when RF energy is supplied to the apparatus.

15. The apparatus as claimed in 14, comprising a second circuit breaker for breaking the contact between the apparatus and external electronics in response to the first circuit breaker cutting the current supply to the apparatus.
